(19) United States
(12) Patent Application Publication
(10) Pub. No.: US 2013/0290204 A1
(43) Pub. Date: Oct. 31, 2013

(54) ENDOWMENT COMPENSATION APPLICATION AND METHOD OF USE

(71) Applicants: Kenneth I. Fox, Orem, UT (US); Larry J. Kane, Marion, IA (US)

(72) Inventors: Kenneth I. Fox, Orem, UT (US); Larry J. Kane, Marion, IA (US)

(21) Appl. No.: 13/872,560

(22) Filed: Apr. 29, 2013

Related U.S. Application Data
(60) Provisional application No. 61/639,572, filed on Apr. 27, 2012.

(51) Int. Cl. G06Q 10/10

(52) U.S. Cl. CPC G06Q 10/1053
USPC 705/320

(57) ABSTRACT

An application for endowment compensation where commissions are determined and calculated based upon the type of harvest account such as a seed account, direct sales account, and indirect sales account; a commission percentage; and a cap or limit that are set as parameters by a company.

### CROSS REFERENCE TO RELATED APPLICATION

This application claims the benefit of U.S. Provisional Application No. 61/639,572 filed Apr. 27, 2012.

### BACKGROUND OF THE INVENTION

This invention relates to compensation for sales. More specifically, and without limitation, this invention relates to an application and method for rewarding sales.

Compensating salespersons for making sales is known in the art. Herein, the terms “salesperson” or “salespersons” are non-limiting and can include any person, group of persons, organization, entity, company, partnership, or the like. Providing compensation for making sales is an effective way of incentivizing salespersons to generate sales. There are many ways of compensating salespersons for making sales. Two examples of how salespersons can be compensated are described below.

### Example 1

### Direct Sales Compensation Method

In the Direct Sales Compensation Method a salesperson is directly compensated for each sale they make when they make it. As an example, assuming a salesperson “Allen” sells a product for a company and earns a direct commission of $100.00 per sale. In this example, if Allen wants to earn a modest $3,000 per month income he must make 30 sales a month, or approximately 1 sale a day. While this arrangement works to incentivize Allen to make sales, the upside potential for Allen is limited. In addition, Allen has no ongoing stream of income. After each sale Allen is essentially out of work and must continue searching for new customers. This system often leads to high salesperson turnover because of the limited income the salesperson can earn and the fact that there is no ongoing stream of income. In addition, while the salesperson is incentivized to make sales, they are not incentivized to recruit other salespersons.

### Example 2

### Modified Direct Sales Compensation Method

The Modified Direct Sales Compensation Method is an improvement over the Direct Sales Compensation Method. In this method salespersons are paid not only for the sales of products they directly sell, but they are also paid a portion of the commission made on sales by salespersons that they recruit. This system is designed to create an ever increasing number of referral sales to the participating salesperson and a growing number of new salespersons for the company.

### SUMMARY OF THE INVENTION

Despite these advances, problems still remain. Namely, problems remain in compensating salespersons appropriately. In the modified system, there is no way to control the amount of income generated by recruitment. Another problem is that allocating the proper commission becomes very difficult and complex.

Thus, it is a primary object of the present invention to provide a compensation application that improves upon the state of the art.

Another object of the present invention is to provide the salesperson with an ongoing stream of income.

Yet another object of the present invention is to incentivize the recruitment of new salespersons.

Another object of the present invention is to provide a manner of controlling the compensation of salespersons.

These and other objects, features and advantages of the present invention will become apparent from the specification, drawings and claims.

### BRIEF DESCRIPTION OF THE DRAWINGS

FIG. 1 is a schematic view of the environment for endowment compensation application; and

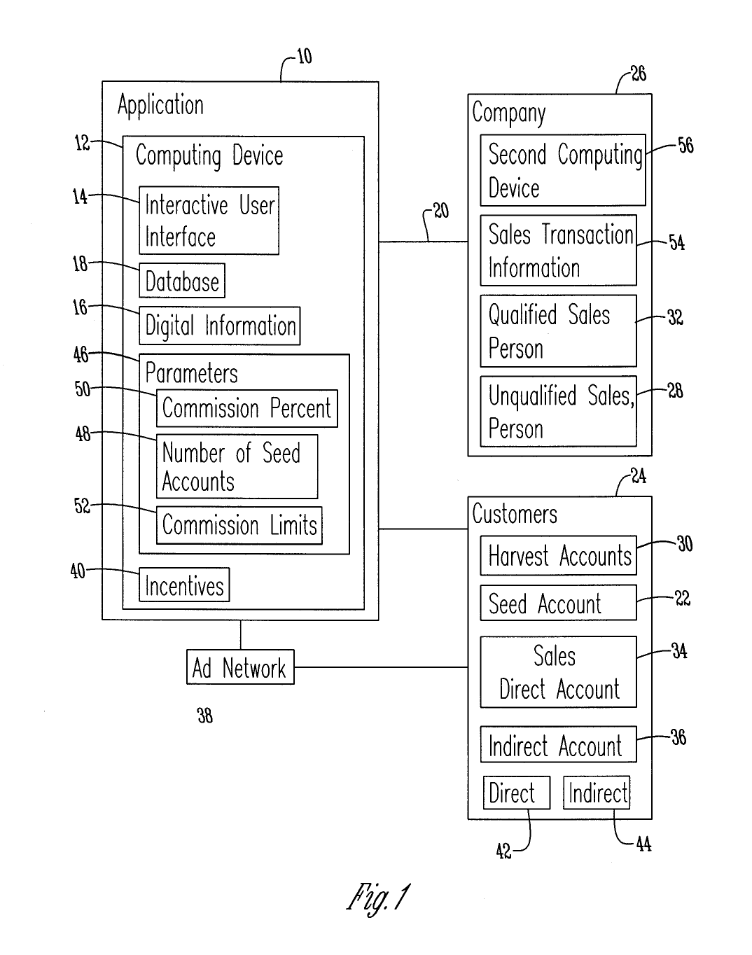

FIG. 2 is a flow diagram for a method of using endowment compensation application.

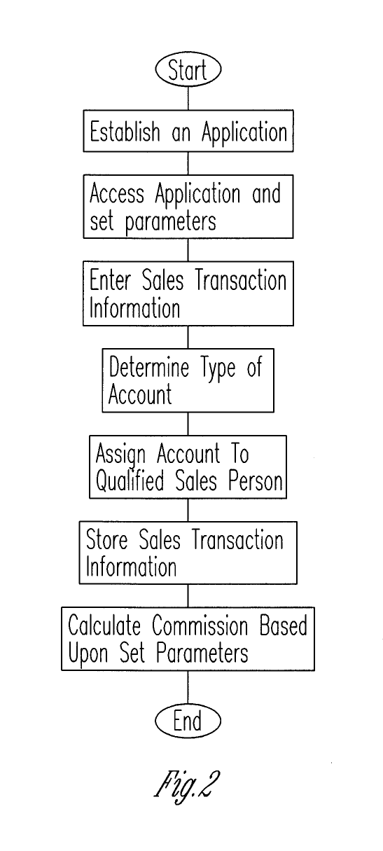

### DETAILED DESCRIPTION OF THE INVENTION

With reference to the drawing, an endowment compensation application 10 and method of use is presented. The application 10 is used to allocate compensation based on sales. The application 10 has at least one computing device 12 with an interactive user interface 14 that allows access to and storage of digital information 16 in a database 18 over an electronic network 20. Computing device 12 is any device which computes information such as a desktop computer, a laptop computer, a tablet computer, a smart phone, an iPad®, an iPhone®, a Blackberry®, or any other handheld or fixed computing device. Interactive user interface 14 is any interface that the user can interact with to input and receive information. Preferably interactive user interface 14 is displayed on a screen to the user. Digital information 16 is any information stored on database 18 needed to support and for the function of application 10. Database 18 is any form of information storage such as a flash drive, a hard drive, a server, a network, the cloud, the internet, or the like. Database 18 can represent a single storage device located in a single physical location, or otherwise database 18 can consist of several or countless storage devices or databases located in multiple places or located in cyberspace. Electronic network 20 is any wired or wireless network which electronically connects computing devices such as the internet, a wireless network, a cellphone network, a phone network, a cable network or the like.

### Terms Defined

A SEED ACCOUNT 22—In one arrangement, a seed account is a non-commissionable sale. Before a new salesperson qualifies to receive commissions on customers 24 they introduce to the company 26 they are required to give up their first few customers 24 to the salesperson who recruited them or to the company 26 directly if they are contracted directly with the company 26. Some or all of the commissions earned are retained by the company 26 or paid to the salesperson who recruited this new salesperson.

The purpose of creating seed accounts 22 is to begin an ongoing process where the new salesperson 28 gives up a small number of sales in the beginning with the expectation of receiving an ongoing and much larger number of sales given back to them as they hire new sales people. A great analogy would be to look at a farmer who “gives up” the ability to eat a small amount of corn and instead sees the relatively small amount of initial corn kernels as seeds. He does this because he fully expects to reap a harvest of corn kernels hundreds of times larger than the number of seeds he gave up. The productive farmer looks at seeds as investments and realizes that it is up to him to convert the investment into a valuable reward. Just like the farmer, this process encourages the new salesperson to take a more long term approach to their sales efforts since they pay a price in the beginning by giving up a few sales (their seed accounts) with the expectation that the longer they continue their sales efforts the greater should be their reward as they reap an ever increasing number of referral sales from new salespeople they hire thus creating a sales harvest.

The number of seed accounts 22 a new salesperson 28 must give up to qualify for future commissions is a specific number set by the company 26 which can be any amount. However, this is commonly the first 2 to 5 sales a new salesperson 28 makes.

A HARVEST ACCOUNT 30—In one arrangement, a harvest account 30 is a commissionable sale that is designed to do much more than just create a commission for the qualified salesperson 32 as a simple referral would do. A harvest account 30 is designed to produce an ever increasing number of referral sales (the harvest) as a reward for the small number of seed accounts 22 a new salesperson 28 gave up to their recruiter in order for them to become qualified for commissions.

A QUALIFIED SALESPERSON 32—In one arrangement, a qualified salesperson 32 is the person who will receive the full commission on the sales made to the account. Or alternatively, the qualified salesperson 32 will receive a portion or percentage of sales made to this account.

AN UNQUALIFIED SALESPERSON 28 or NEW SALESPERSON—In one arrangement, an unqualified salesperson 28 or new salesperson is the person who will not receive a full commission on sales made to the account because they have not exceeded the required number of seed accounts 22.

Two potential sources for harvest accounts 30 are as follows:

Direct Sales 34—Once the new salesperson 28 has given up the required number of seed accounts 22 to the salesperson who recruited them and therefore now qualifies for commission on all future customers each new customer 24 they generate personally will be considered a harvest account 30 and will be commissionable to the newly qualified salesperson 32.

Indirect Referral Sales 36—Each new salesperson 28 recruited by a qualified salesperson 32 will be required to give up their first few sales to the qualified salesperson 32 who recruited them. These new customers being referred are considered harvest accounts 30 to the salesperson who recruited the new salesperson 28 and seed accounts 22 to the new recruit 28 who seeks to qualify for commissions in this process.

To a customer 24 being given up to their salesperson's recruiter this customer 24 may view the salesperson who introduced them to the company as their main contact. However, internally, there are now two sales people involved in all sales made by a non-qualified salesperson 28. Salesperson #1—The unqualified salesperson 28 or new salesperson who actually sold the customer 24 where the customer 24 is considered a seed account 22 of their salesperson 28 and therefore their salesperson 28 is not qualified yet to earn a commission and salesperson #2—32 the qualified salesperson 32 who recruited the new salesperson 28 and will receive both the full commission on sales generated by this customer 24 who is considered a harvest account 30 of this qualified salesperson and will also receive any and all future direct 34 and indirect 36 seed customers 24 who are initially referred to this qualified salesperson 32 through an unlimited number of referral generations (see below for details).

A component of this process is to realize that the qualified salesperson 32 in each sale will not only receive the commission on the required number of referral sales or seed accounts 22 referred to them by each of their new recruits 28 but they will also reap the harvest if and when these initially referred customers then refer one or more customers 24 to the company 26 and potentially through this ongoing process an increasing number of indirect referral sales 36 are generated. Any customers referred by each harvest account 30 of any qualified salesperson 32 at any point in the future and all indirect customers referred by them through an unlimited number of referral generations are considered customers of the qualified salesperson 32.

An Advertising Network 38—Each harvest account 30 is given incentives 40 to produce referral customers that are commissionable to their qualified salesperson 32. So each harvest account 30 is looked on as more than a customer 24; they are a potential word of mouth advertising network 38 and have the potential to generate hundreds of referral sales to their qualified salesperson 32. Starting with them and then potentially expanding to an unlimited number of direct 42 and indirect 44 referral sales each harvest account 30 has the potential to grow into a larger and larger amount of referral sales.

A Direct Referral 42—is when person #1 refers person #2 through word of mouth or any other form of direct communication, social networking, oral communication or the like.

An Indirect Referral 44—is when person #1 refers person #2 who then refers person #3 who then refers person #4 who then refers person #5 who then refers person #6 who then refers person #7. In this example person #3 is an indirect referral of person #1. Person #3 is also a direct referral of person #2.

Note: indirect referrals 44 can grow through an unlimited number of generations. So using the example of an indirect referral above, the person:
#2 would be a 1st generation direct referral of person #1
#3 would be a 2nd generation indirect referral of person #1
#4 would be a 3rd generation indirect referral of person #1
#5 would be a 4th generation indirect referral of person #1
#6 would be a 5th generation indirect referral of person #1
#7 would be a 6th generation indirect referral of person #1

Point of interest here is that research shows that everyone on earth is within 6 generations of referrals from knowing everyone else on earth. Due to the powerful new social networking technologies like Face Book, You Tube, Twitter, Smart Phones, etc. referral marketing is without a doubt the most powerful and relatively untapped advertising resource in history.

In the seed to harvest process each harvest account 30 is also the beginning of a potentially large advertising network. The advertising network 38 is the combined total number of individuals at any point in time who have all been referred directly or indirectly through a single initial person. Each member of an advertising network 38 has an incentive 40 to refer a specified number of new seed accounts 22 in order to qualify to receive commissions on all future customers plus the potential harvest accounts that these future customers may generate.

### Example of an Advertising Network

For the purpose of this example we will assume that every new salesperson that Allen recruits and every new customer that Allen generates directly in turn decides they want to qualify to earn commissions and so they give up 3 customers each to Allen.

### Point by Point Example

1. Allen gives his first 3 customers to his sales trainer and loses $300.00 in commissions. These 3 initial customers are his Seed Customers.

2. He is now qualified to earn a commission on all future customers he generates directly.

3. He will also earn a full commission on all 3 seed accounts he receives from each new salesperson he recruits. Each of these seed accounts become part of Allen's growing number of harvest accounts.

4. Allen recruits his next 3 customers who become his first 3 harvest accounts and he earns a full commission on each sale.

5. These first 3 harvest accounts must each give up their first 3 seed accounts to Allen before they can qualify to earn commissions. So at that point Allen's harvest accounts grow by 9.

6. This process then could continue indefinitely and in that case these 9 new salespersons give Allen a combined 27 who give Allen a combined 81, who give Allen a combined 243, who give Allen a combined 729, who give Allen a combined 2,187 new seed accounts. And this growing number of Allen's harvest accounts would potentially continue increasing by a factor of 3 generationally and indefinitely (generational sales explained below).

7. At this point, the total seed accounts that Allen has received in this illustration is 3+9+27+81+243+729+2,187 for a total of 3,279 new customers and been paid $100.00 on each sale for a total commission of $327,900. Since he only gave up his first 3 customers for a cost of $300.00 he has done well. And his potential earnings are just beginning. Now when these 2,187 new customers refer their 3 seed accounts each to Allen, he will have a total of 6,561 new customers.

8. Finally, keep in mind that Allen is not restricted to receiving only the growing number of seed accounts given up to him by his 3 initial harvest accounts; he can also continue to make direct sales and since he is now a qualified salesperson each of them will be commissionable as harvest accounts.

Note: The sales volume being illustrated in this example is being created by Allen's initial 3 harvest accounts which are also new recruits that Allen introduced to the company through their 6 generations of indirect customers referred to Allen. (See #4 above). This process however never stops and can continue producing a larger and larger income stream as the referrals expand beyond this initial 6 generations. He is free to recruit as many new salespersons as he is willing to do and each new direct recruit Allen introduces to the company (once he is qualified) has the potential to grow to 1,000s of referral sales.

If the commissions he is earning in this example are on an item that his customers repurchase on a regular basis the $327,900 in earned commissions described in #7 above could continue paying Allen over and over again monthly on this same customer base. That would be quite a nice “Harvest” from the actual sale of just 6 initial customers one time.

So as this illustration explains the purpose of this existing seed to harvest process is to convert one sale into an ever increasing number of referral sales for any participating salesperson who participates in this existing Seed to Harvest direct sales commission tracking process as described above. It also tends to increase the value of each customer because individual customers can grow into 1,000s of referral customers. Therefore, this possibility encourages an increase in sales and marketing activity.

In this illustration the salesperson, Allen, sold his initial 6 customers directly through his combined sales, marketing, and advertising effort. Of these 6 initial customers he gave up his first 3 sales as seed accounts (see #1 above) and then he sells his next 3 customers who become his first 3 harvest accounts (see #4 above). As Allen's 3 harvest accounts refer their 3 seed accounts to Allen so they can qualify to earn commissions, the eventual 3,279 sales that were referred to Allen indirectly were primarily due to the Seed to Harvest referral (or word of mouth advertising) network that this process created, and had much less to do with his effort. This growing network of referral sales is defined as the advertising network because that is how it functions.

Modification to this Seed to Harvest Commission Tracking and Payment Process

A modification to the seed to harvest commission tracking payment process includes how commissions generated from any advertising network are distributed. It places a limit on the compensation any salesperson can earn on the sales production of each of their advertising networks individually or on the combined production of all of their advertising networks. This modified process creates multiple new business applications that are each potentially very beneficial and very profitable to the business community and to society at large.

### The Cap

First, the maximum amount of compensation paid to a salesperson on each advertising network they produce is determined. Or, alternatively, the total amount of gross profits their combined advertising networks produce is determined. This is their cap. Second, all direct sales and all indirect sales generated by participating salespersons advertising networks are tracked through the application weekly, monthly or at any other designated time period. This total provides the gross profit produced by all sales credited to this salesperson. Third, the compensation due each salesperson is then calculated.
In one arrangement, personal direct sales do not fall under the cap. Each direct sale earns a full commission.
In another arrangement, if an advertising network has not exceeded the maximum number of sales that would exceed the cap then all of their sales earn the qualified salesperson a full commission.
In another arrangement, if an advertising network has exceeded the maximum number of sales that do exceed the cap then the salesperson is paid on all of their sales up to the number that equals their cap amount and all additional sales are profit to the company.

Note: In this modification that I called an endowment compensation tracking calculation process any type of compensation can be used including but not limited to commission, salary, bonus, profit sharing or any combination of any form of compensation. If compensation is salary based the salesperson may have their salary cap adjusted from time to time based on whatever calculation chosen, which is typically sales volume. The company may use bonuses or profit sharing in addition to salary.

If the compensation is commission based each product or service sold will be assigned a specific amount of compensation which will be paid to the designated salesperson on each of their advertising networks separately or combined as long as the compensation does not exceed the cap.

### Examples of the Cap in Operation

In this commission only compensation calculation process example, commissions are paid once a month. First, the amount of the cap is determined which places a limit on the amount of commissions a salesperson can earn per advertising network each month. Second, each item sold is assigned a commissionable amount. This can be fixed or variable based on volume for example. Third, once the cap and the amount of commission each sale produces are determined, the total commission is calculated until the cap is reached. If the last sale necessary to reach the cap also exceeds the cap, either the full commission on this last sale is paid or only a portion of the normal commission is paid so that the total commission paid out equals the cap exactly. All sales made after the CAP is reached earn no commissions and all profits on those sales are retained by the company each month.

The Cap is Flexible Depending on the Product being Sold

To illustrate the flexibility of this process two product illustrations are presented:

ILLUSTRATION #1—A consumable item that the consumer buys often each month (like groceries) which have a small mark up. The commission is 1% of the total sales on groceries each month per customer. So if a typical household of 4 spends $600.00 per month on groceries and the commission is 1% of their total monthly sales, the salesperson will be paid $6.00 per month per customer. If the cap is $100.00 per month per advertising network the salesperson will reach the cap on the first 16 or 17 sales per month generated per advertising network ($6.00/sale×16 sales=$96.00) or ($6.00/sale×16 sales−$102.00). In this example, the salesperson is paid wither $100.00 if the cap is the ceiling, or the salesperson is paid $102.00 if the salesperson is allowed to receive the full commission on the sale when the cap is reached.

ILLUSTRATION #2—This illustration demonstrates how adaptable this CAP can get. In this example, the product is typically purchased every 5 years or more (like a car) but has a direct commission of $1,000 per sale. The gross commission per sale is $1,000 with 60 month between purchases. The commission is $1,000 divided by 60 months which equals $16.67 per month in estimated average monthly commissions per sale if the pay out is over 60 months. If the cap is $100.00 per month on the referral sales of this product generated by each of their advertising networks the maximum commission we will pay out on this product at $16.67 per month for 60 months. In this example just 6 car sales generates $100.02 per month in earned commissions from this advertising network and the salesperson has exceeded the cap. So even though car sales are likely to continue being produced by this advertising network it will take 60 months for this commission stream to end. However after 60 months it is likely that this advertising network will be exceeding 6 car sales a month and so it is likely that this commission stream will continue at this amount indefinitely to this salesperson on each advertising network that is reaching or exceeding their cap on this product each month.

Comparison Example Illustrating the Difference Between how Existing Seed to Harvest Direct Sales Compensation Calculate Compensation Vs how this Modification Calculates Compensation Derived from the Identical Sales Volume

In this example a $2.00 commission paid monthly on a consumable service that will be attractive to every consumer. A newly qualified salesperson generates a customer who refers 3 direct sales to them who refer 9 second generation indirect sales who refer 27 third generation indirect sales who refer 81 fourth generation indirect sales who refer 243 fifth generation indirect sales to the newly qualified salesperson. At this point the salesperson has indirectly generated a total of 363 customers in a single growing advertising network created by his initial customer. In this example only the first 3 direct referrals were produced by this salesperson's efforts. Each of the remaining 360 referral customers generated through five generations of referrals simply went to our web site and ordered our service at the direct suggestion of a satisfied customer. The 360 referred customers never spoke to the salesperson.

Without the cap, the designated salesperson would earn the full commission on the three direct customers he worked to find and each of the additional 360 customers referred to him through the growing advertising network being created by his three direct customers. His total commissions would be $726.00 per month on the personal sale of just three direct customers who are buying an inexpensive product probably costing less than $20.00 per month.

With the cap, the salesperson will be paid $100.00 each month on the sales production of this single advertising network and the remaining ($626.00) per month will be retained by the company.

Modifications to the Cap—Different sources of customer or sales generation can be capped differently. As one example a cap of $25 dollars can be put on sales generated through Facebook referrals. Research shows the average person in America had 167 friends on Facebook. If a customer of the system was just average and was able to refer 20% of their Facebook friends to the system to become a customer could earn $25.00 per month times 16 referred customers. If these 16 referred customers each produced an advertising network of indirect referral customers that meet the cap of $25.00 per month the customer would earn $400.00 per month. With this success, the customer can inform their remaining 150 friends on Facebook that this process is paying them $400.00 per month, their remaining friends will be incentivized to join the system. If the remaining friends join the system and each produce an advertising network for that reaches their $25.00 cap the customer would then earn $25.00 per month on their 167 fully capped advertising network and would then be earning $4,175.00 per month.

Another Modification to the Cap—As another example, retailers can be capped at $50.00 per month per advertising network. If a retailer serves 50 customers a day, seven days a week, at the end of each month they have served 1,500 customers a month or 18,000 customers a year. If 20% of them participate in our program in a year a retailer could produce 3,600 participating customers. If 10% of them (or 360) produce an advertising network that reaches their cap in a year each retailer who produces at this level could be generating $18,000 a month in earned commissions (360×$50.00).

Another modification includes paying an account executive assigned to a territory a base salary and bonuses or profit sharing based on performance.

Yet another modification includes capping a large organization such as a church, charity, union or school on a volume based scale such as:
1-100 members $25 per month per member
101-1000 members $50.00 per month per member
1,001-10,000 members $100 per month per member

In operation, a company 26 accesses the application 10 via the electronic network 20 through the interactive user interface 14. Once activated, the company 26 sets or configures parameters 46 that determine when commissions will be paid, how much the commissions will be, and who will receive the commissions. For example, a company 26 would determine the number 48 of seed accounts 22 an unqualified sales person 28 needs before they become a qualified sales person 32. The company 26 would also determine the commission percentage 50 based on whether the account is a direct 34 or indirect account 36. Also, the company would set limits or caps 52 on commissions as discussed above.

When a sale is made, sales transaction information 54 is input by an unqualified 28 or qualified 32 sales person into a second computing device 56. The sales transaction information 54 includes the source of customer type, sales person information, the price, the product/service and any discounts applied. Alternatively, the application 10 is accessed via the electronic network 20 and the sales transaction information 54 is input through the interactive user interface 14. Once input, the sales transaction information 54 is transmitted or transferred to the application 10.

Upon entry or transmission, the application 10 determines the type of harvest account 30 based on the sales transaction information 54, assigns the harvest account to the qualified sales person 32, stores the sales information 54 in the database 18, and calculates a commission for the qualified sales person 32 based upon the parameters 46 set by the company 26.

### IN CONCLUSION

Due to the historic power that social media has brought to traditional word of mouth advertising, the ability for any individual in the world to communicate information to and motivate millions of individuals into action using various social networks online is literally changing the world. The key to social network/social media marketing is having a truly valuable offer that motivates people to talk and take action. The offer must “go viral”. If it does, the benefits are staggering. We now live in a time where for the first time in history it is technologically possible for any single individual in the world to communicate with every human being in the world.

Therefore the goal of this invention is to establish an “endowment” for every religious, educational, and charitable organization in the world which produces an ever increasing and ongoing stream of income that is designed is designed to continue for generations and can be sent to the organization.

It will be appreciated by those skilled in the art that other various modifications could be made to the device without parting from the spirit and scope of this invention. All such modifications and changes fall within the scope of the claims and are intended to be covered thereby.

What is claimed:

1. A method of compensating a sales person based upon an endowment, comprising the steps of:
establishing an application connected to a computing device having an interactive User interface accessible via an electronic network and a database for storing digital information;
accessing the user interface by a company via the electronic network and setting parameters for commissions based upon a type of harvest account;
entering sales transaction information into a second computing device and transmitting the sales transaction information to the application via the electronic network;
wherein the application determines the type of harvest account based on the transmitted sales transaction information, assigns the harvest account to a qualified sales person, stores the transmitted sales transaction information in the database, and calculates a commission for the qualified sales person based on the parameters set by the company.

2. The method of claim 1 wherein the step of setting parameters includes setting a commission percentage for direct and indirect sales.

3. The method of claim 1 wherein the step of setting parameters includes setting a number of seed accounts needed before becoming a qualified sales person.

4. The method of claim 1 wherein the step of setting parameters includes setting commission limits for the type of harvest account.

5. The method of claim 1 wherein the step of entering sales transaction information includes entering information on a sales person, a product/service, a price, and a source.

6. The method of claim 1 wherein the determined type of harvest account is one consisting of a group of seed account, direct account, and indirect account.

7. The method of claim 1 wherein the qualified sales person is a recruiting sales person when the type of harvest account is a seed account.

8. The method of claim 1 wherein the qualified sales person is a recruiting sales person when the type of harvest account is an indirect account.

9. The method of claim 1 further comprising the step of transmitting incentives for referrals from the application to harvest accounts via the electronic network.
